(19) United States
(12) Patent Application Publication
(10) Pub. No.: US 2018/0023535 A1
(43) Pub. Date: Jan. 25, 2018

(54) Method and Plant for Exploitation of the Energy of a Water Current

(71) Applicant: Tidal Sails AS, Haugesund (NO)

(72) Inventor: Are Børgesen, Haugesund (NO)

(73) Assignee: Tidal Sails AS, Haugesund (NO)

(21) Appl. No.: 15/547,991

(22) PCT Filed: Feb. 2, 2016
(86) PCT No.: PCT/NO2016/050016

§ 371 Date: Aug. 1, 2017

(30) Foreign Application Priority Data
Feb. 5, 2015 (NO) 20150164

(51) Int. Cl. F03B 7/00; F03B 3/18

(52) U.S. Cl. CPC F03B 7/006; F03B 3/183

(57) ABSTRACT

A method is for exploiting the energy of a water current with an energy plant. The energy plant has at least one rope extending around at least two turning stations, and carries at least one at least partially submerged foil which is approximately symmetrical around its chord. The velocity and direction of flow of the water together with the moving speed and direction of the foil gives a resulting water velocity and direction acting on the foil. The method includes pivoting the foil until it has a desired angle of attack to the resulting water direction when the foil is being displaced co-currently; and pivoting the foil until it has a desired angle of attack to the resulting water direction when the foil is being displaced counter-currently, the angle of attack being the same or different co-currently and counter-currently.

### FIELD

This invention relates to a method for exploiting the energy of a water current by means of an energy plant. More particularly, it relates to a method for exploiting the energy of a water current by means of an energy plant placed in the water current, the energy plant including at least one rope extending around at least two turning stations and there being, arranged along the rope, at least one at least partially submerged foil which is approximately symmetrical around its chord, and the flow velocity and direction of the water together with the moving speed and direction of the foil giving a resulting water flow velocity and direction acting on the foil. The invention also includes an energy plant for use when practising the method.

### BACKGROUND

By the term “foil” is meant, in this connection, a whole body or a compound body, which is designed to give a favourable flow pattern when energy is being extracted from flowing water. The term also includes sails that are used for the same purpose.

The term “rope” comprises any suitable elongated flexible body, typically in the form of a fibre rope, wire, chain or combinations thereof.

From NO 333432 it is known to arrange foils along a submerged track, in which the foils co-current adjust relative to the direction of flow. When the foils are being displaced against the current, the foils are set in a neutral position with the aim of making them offer as little flow resistance as possible.

GB 2131491 deals with equipment for extracting energy from wind or water, in which a number of foils are arranged along an endless belt, which, in the embodiment for water, is displaced perpendicularly to the water flow. The foils are approximately symmetrical around their chords, and the chords are parallel to the belt.

In an embodiment as described in NO 333432, it is obvious that there will be an energy loss on the counter-current leg, reducing the total efficiency of the energy plant. According to GB 2131491, there is no counter-current leg, as the belt is perpendicular to the water flow on the outbound leg and the return leg.

### SUMMARY

The invention has for its object to remedy or reduce at least one of the drawbacks of the prior art or at least provide a useful alternative to the prior art.

The object is achieved through the features, which are specified in the description below and in the claims that follow.

With the exception of the solution that is shown in GB 2131491, in an energy plant that works according to the principle of letting foils along a rope be affected by flow forces, there will always have to be a counter-current leg on which the angle between the leg and the direction of flow of the water is less than 90 degrees.

By letting the rope on the counter-current leg have an angle of between 1 and 45 degrees and orienting the foil with an angle of attack to the resulting water direction, the foil is subjected to forces from the water current in a manner corresponding to that which, in sailing, is termed “by the wind”, as the foil gives a force component which is directed along the counter-current leg. Thereby a relatively substantial amount of energy can be extracted also when the foil is being displaced up-stream.

It should be noted that in sailing there is some confusion around the term “by the wind”, as some call the situation in which the angle between the sailing direction and the wind direction is between 90 and 45 degrees “close reach”.

The invention is defined by the independent claims. The dependent claims define advantageous embodiments of the invention.

In a first aspect, the invention relates more specifically to a method for exploiting the energy of a water current by means of an energy plant which is placed in the water current, the energy plant including at least one rope extending around at least two turning stations, and there being, arranged along the rope, at least one at least partially submerged foil which is approximately symmetrical around its chord, and the velocity and direction of flow of the water together with the moving speed and direction of the foil giving a resulting water velocity and direction acting on the foil, characterized by the method including the following steps:

pivoting the foil until it has a desired angle of attack to the resulting water flow direction when the foil is being displaced co-currently; and

pivoting the foil until it has a desired angle of attack to the resulting water flow direction when the foil is moved counter-currently, the angle of attack by co-current displacement being the same as or different from the angle of attack by counter-current displacement and being greater than zero.

By co-current is meant that the direction of displacement of the foil has a displacement component that coincides with the water flow direction. By counter-current is meant that the direction of displacement of the foil has a displacement component, which is the opposite of the water flow direction.

By the very fact of the resulting water velocity being different counter-currently and co-currently, the desired angle of attack at the foil will be different counter-currently and co-currently. The reason may be a limitation of the lateral forces that will have to be absorbed by the rope or a best possible exploitation of the energy from the water.

Calculations and tests show that the method may include letting the angle of attack be between 1 and 20 degrees.

To achieve the necessary functional reliability, it may be necessary for the method to include letting a controllable switching body pivot the foil into the active position by concurrent displacement.

The switching body is normally arranged in such a way that it provides for the foil to take its active position as it sets off on its co-current leg. Should the foil set itself into its passive position, the energy plant will stop. Trials have shown that the force required in order to set the foil correctly is relatively modest.

Correspondingly, it may be necessary to guide the foil into its active position before it sets off on its counter-current leg.

The method may include providing a turning station with a supporting body, which has a larger diameter than a rope pulley at the turning station, the supporting body striking against the foil at the turning station.

In a second aspect, the invention relates more specifically to an energy plant which is placed in a water current and includes at least one rope extending around at least two turning stations, and in which there are, arranged along the rope, at least one at least partially submerged foil that is approximately symmetrical around its chord, and in which the velocity and direction of flow of the water together with the moving speed and direction of the foil give a resulting water flow velocity and direction that act on the foil, characterized by the foil having been pivoted to have a desired angle of attack to the resulting water direction when the foil is being displaced co-currently, and an identical or different angle of attack to the resulting water direction when it is being displaced counter-currently.

The energy plant may include a controllable switching body, which is arranged at the co-current displacement. The function of the switching body is described above, and the switching body may consist of a wheel or a flap, for example, which is arranged at each of the turning stations and will strike the foil when the switching body is in its active position. The switching body may be moved between its active and passive positions by means of the water current or by means of an actuator.

At least one turning station may be provided with a supporting body, which is arranged to strike the foil as the supporting body has a larger external diameter than a rope pulley at the turning station.

By the supporting body being outside the external diameter of the rope pulley, the supporting body will always put the foil into the active position thereof before it sets off on the counter-current leg.

Other forms of switching and supporting bodies may of course be used to achieve desired functions. For example, the switching body may be of such a design that it is turned around the centre axis of the turning station to a new active position as the water current turns.

The foils according to the applicant's own NO 333432 are well suited for use in the energy plant even if other foils having mainly the same properties may be usable as well.

In a symmetrical design, the energy plant according to the invention is just as suitable in tidal flows as in rivers or other water currents in which the direction of flow does not change.

When the foil is displaced through the water, a lift L and a drag (flow resistance) D develop.

The force acting along the rope is given by the formula

T=−D cos(γ)+L sin(γ)

in which γ indicates the angle of the relative direction of flow; see the special part of the description.

By being able to extract energy from the water current also when the foil is displaced along the counter-current leg, the invention according to the method and system provides a considerable improvement of the total efficiency of the kind of energy plant concerned.

### BRIEF DESCRIPTION OF THE DRAWINGS

In what follows, an example of a preferred method and embodiment is described, which is visualized in the accompanying drawings, in which:

FIG. 1 shows a principle drawing of an energy plant according to the invention;

FIG. 2 shows a section of FIG. 1, in which a foil is being brought into its active position;

FIG. 3 shows a section of FIG. 1, but in which a foil is in its passive position;

FIG. 4 shows a side view of a foil;

FIG. 5 shows an end view of the foil of FIG. 4;

FIG. 6 shows a diagram of flow directions and forces when the foil is on the co-current leg;

FIG. 7 shows a diagram of flow directions and forces when the foil is on the counter-current leg; and

FIG. 8 shows a view as indicated by I-I in FIG. 1.

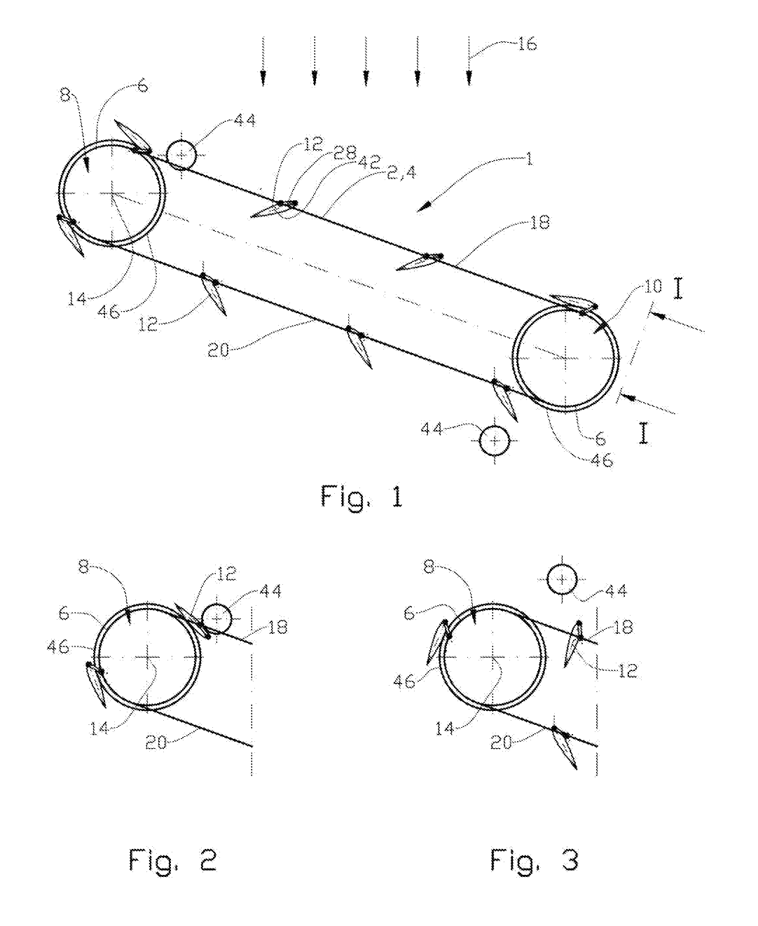

### DETAILED DESCRIPTION OF THE DRAWINGS

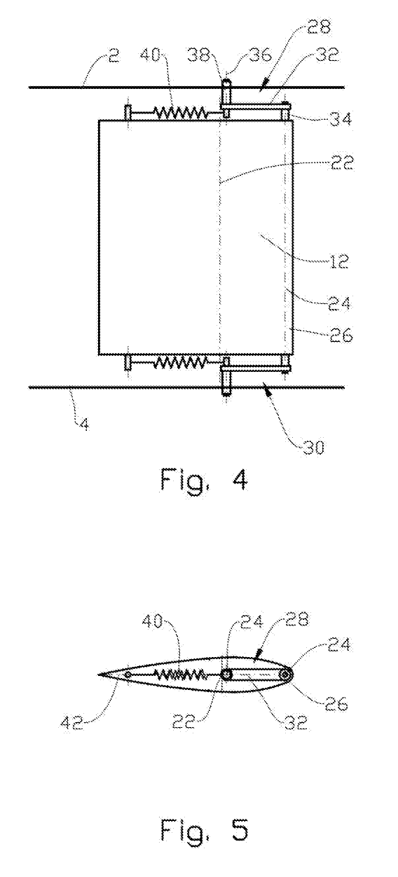

In the drawings, the reference numeral 1 indicates an energy plant which includes an endless upper rope 2 and an endless lower rope 4 extending around rope pulleys 6 at a first turning station 8 and a second turning station 10. A number of foils 12 are attached to the upper rope 2 and the lower rope 4; see FIG. 4. The ropes 2 and 4 may include several individual ropes.

The terms “upper” and “lower” refer to relative positions when, in a state of application, the energy plant 1 is arranged with vertical turning-station axes 14.

In the exemplary embodiment shown, the direction of rotation of the rope pulleys 6 is clockwise. The stretch between the first turning station 8 and the second turning station 10 in the water current 16 constitutes a co-current leg 18, whereas the return leg constitutes a counter-current leg 20.

As the rope pulleys 6 are of the same diameter here, the co- and counter-current legs 18, 20 are parallel and are here at an angle in the order of 70 degrees to the water current 16.

The foil 12 has a lift centre 22 and a rotational axis 24 near the front portion 26 of the foil 12. The foil 12 is provided with an upper foil suspension 28, which is attached to the upper rope 2, and a lower foil suspension 30, which is attached to the lower rope 4.

Each foil suspension 28, 30 includes an arm 32, which is rotatably connected to an axle 34 and thereby rotatable around the rotational axis 24. The arm 32 has a suspension axis 36 at a distance from the rotational axis 24. Couplings 38, which are rotatable around the suspension axis 36 are connected to the upper rope 2 and the lower rope 4, respectively. An elastic element 40, here in the form of a tensioned spring, seeks to rotate the arm into a parallel position relative to the chord 42 of the foil 12. The elastic element 40 may be replaced by an actuator not shown or other suitable equipment.

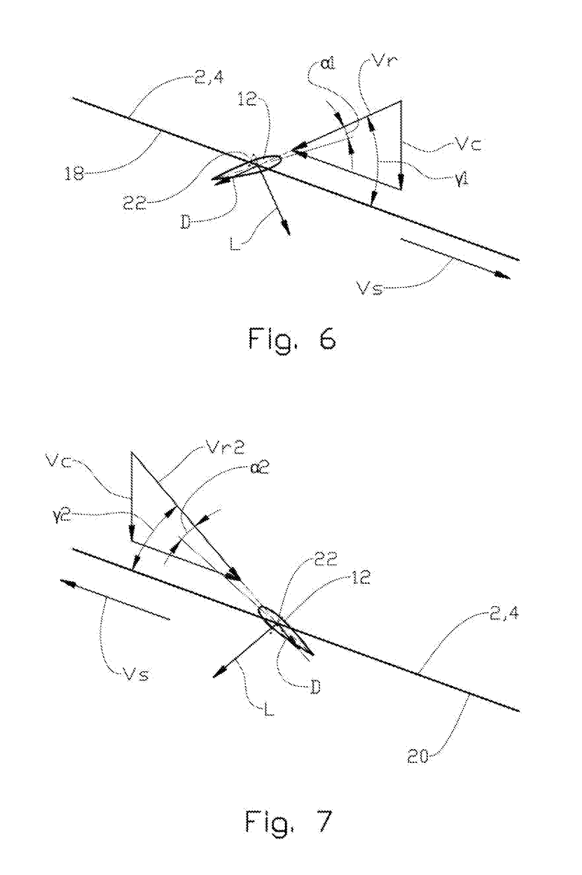

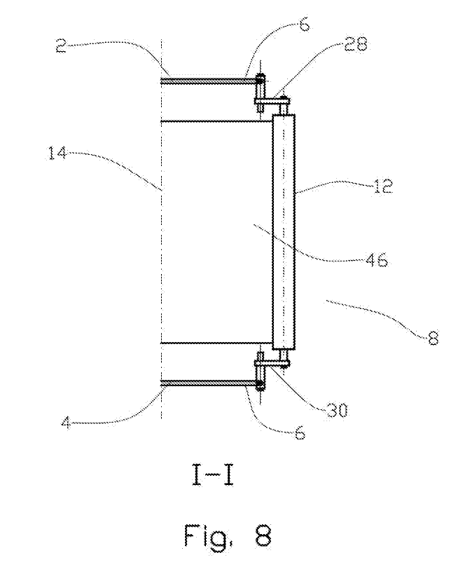

The water current 16 has a velocity and a direction that are indicated by the arrow Vc, and the speed and moving direction of the foil 12 are indicated by the arrows Vs in FIGS. 6 and 7. FIG. 6 represents the co-current situation, and FIG. 7 represents the counter-current situation. The resulting force and direction of the water current 16 towards the foil 12 are indicated by the arrow Vr1 in FIG. 6 and by the arrow Vr2 in FIG. 7. The relative angle between the resulting water flow direction and the moving direction of the foil 12 is indicated by γ1 in FIGS. 6 and γ2 in FIG. 7.

When the foil 12 is set at an angle of attack a, a lift force L and a drag force D arise, referring to the lift centre 22. The angle of attack α, which may be the same or different at the co- and counter-current legs 18, 20 is chosen on the basis of the prevailing conditions.

The force T acting along the ropes 2, 4 is defined collectively in the general part of the description. The sum of a transverse force N acting transversely to the ropes 2, 4 is given by the formula

N=D sin(γ)+L cos(γ)

The transverse force N may be considerable, and the angle of attack α must be controlled bearing this in mind, among other things. The forces T and N are self-explanatory and are not shown in the figures.

When the energy plant 1 is in operation, the foils 12, when they set off on the co-current leg 18, may take a passive position as indicated in FIG. 3. They may thereby stop the energy plant 1. A switching body 44 which is arranged at each of the turning stations 8, 10, and able to take an active position, see FIG. 2, or a passive position, see FIG. 3, is arranged, in its active position, to strike the foil 12 and thereby ensure that the foil 12 takes its active position when it sets off on the co-current leg 18.

As the foil 12 meets the water current 16, the foil 12 is rotated around the rotational axis 24 towards a favourable position relative to the water current 16. The elastic element 40 is stretched as the arm 32 rotates around the rotational axis 24. The position of the suspension axis 36 relative to the lift centre 22 makes the foil 12 take a position favourable for the purpose at different water flow velocities. The symmetrical design of the foil 12 and also of the upper and lower foil suspensions 28, 30 has the effect of making the foil 12 align correctly in water currents 16 in both directions.

The foils 12 are displaced with the ropes 2, 4 along the co-current leg 18 until they get to the second turning station 10 where they turn around the rope pulleys 6. The second turning station 10 is provided with a supporting body 46, which is arranged to strike the foil 12. The supporting body 46 thereby displaces the foil 12 to the opposite side of the ropes 2, 4. The intention is to ensure that the foil 12 takes its active position when it sets off on the counter-current leg 20 and is displaced towards the first turning station 8.

As the energy plant 1 in the embodiment shown has been adapted for a tidal flow in which the water current 16 turns, a switching body 44 has also been arranged at the second turning station 10 and a supporting body 46 at the first turning station 8.

At a given rope and water speed, each of the foils 12 contributes a force T along the ropes 2, 4.

Thus, energy may be extracted from the energy plant 1, for example by connecting a generator, not shown, to one or more of the rope pulleys 6.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive. The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. A method for exploiting energy of a water current with an energy plant which is placed in the water current, the energy plant having at least one rope extending around at least two turning stations, and there being, arranged along the rope, at least one at least partially submerged foil which is approximately symmetrical around its chord, and the velocity and direction (Vc) of flow of the water together with the moving speed and direction (Vs) of the foil giving a resulting water flow velocity and direction (Vr1, Vr2) acting on the foil, the method comprising:
pivoting the foil until it has a first angle of attack to the resulting water flow direction (Vr1) when the foil is being displaced co-currently;
pivoting the foil until it has a second angle of attack to the resulting water flow direction (Vr2) when the foil is being displaced counter-currently; and
letting a controllable switching body pivot the foil into its active position in co-current displacement.

2. The method according to claim 1, further comprising:
letting the first and second angle of attack be between 1 and 20 degrees.

3. The method according to claim 1, further comprising:
providing a turning station with a supporting body which has a larger diameter than a rope pulley at the turning station, the supporting body striking the foil at the turning station.

4. An energy plant which is placed in a water current, the energy plant comprising:
at least one rope extending around at least two turning stations, and there being, arranged along the rope, at least one at least partially submerged foil which is approximately symmetrical around its chord, and the velocity and direction (Vc) of flow of the water together with the moving speed and direction (Vs) of the foil giving a resulting water flow velocity and direction (Vr1, Vr2) that act on the foil, and the foil having been pivoted to have a first angle of attack to the resulting water direction (Vr1) when the foil is being displaced co-currently, and to have a second angle of attack to the resulting water direction (Vr2) when the foil is being displaced counter-currently, wherein a controllable switching body is arranged at each of the turning stations.

5. The energy plant according to claim 4, wherein the switching body, when in an active position, will strike the foil.

6. The energy plant according to claim 4, wherein at least one turning station is provided with a supporting body which is arranged to strike the foil, as the supporting body has a larger external diameter than a rope pulley at the turning station.

7. The energy plant according to claim 4, wherein the switching body is controllable towards an active position with the water current.

8. The energy plant according to claim 4, wherein the switching body is controllable into an active position with an actuator.
